(19) United States
(12) Patent Application Publication
(10) Pub. No.: US 2017/0169416 A1
(43) Pub. Date: Jun. 15, 2017

(54) HIDDEN WIRELESS SWIPING DEVICE AND POS MACHINE

(71) Applicant: PAX COMPUTER TECHNOLOGY (SHENZHEN) CO., LTD., Shenzhen (CN)

(72) Inventors: Yuzhuo WANG, Shenzhen (CN); Zhiqiang HUANG, Shenzhen (CN)

(21) Appl. No.: 15/108,508

(22) PCT Filed: May 28, 2015
(86) PCT No.: PCT/CN2015/080109

§ 371 Date: Jun. 27, 2016

(51) Int. Cl. G06Q 20/20; G06Q 20/34

(52) U.S. Cl. CPC G06Q 20/208; G06Q 20/34

(57) ABSTRACT

The present invention is applicable to the field of POS machines, and provides a hidden wireless swiping device used in a POS machine and a POS machine using the hidden wireless swiping device. The hidden wireless swiping device comprises a circuit board, a wireless module, a light transmission plate configured to cover the wireless module, and an indicator light mounted on the circuit board; at least one surface of the light transmission plate is a frosted surface, and the circuit board is provided thereon with a control circuit configured to control the wireless module and the indicator light to operate. In the hidden wireless swiping device, the light transmission plate of which one surface is arranged to be a frosted surface covers on the wireless module, the indicator light is arranged on the circuit board, and the control circuit is arranged on the circuit board to control the wireless module and the indicator light to be turned on/off and to operate. When the indicator light stops operating, since one surface of the light transmission plate is the frosted surface, it is difficult to see structures in the POS machine through the light transmission plate, and thus invisibility is realized. When the wireless module needs to be used, as long as the wireless module and the indicator light are controlled by the control circuit to operate, the wireless module can be enabled to operate.

### FIELD OF THE INVENTION

The present invention relates to the technical field of POS (Point Of Sale) machines, and more particularly to a hidden wireless swiping device used in a POS machine and a POS machine using the wireless swiping device.

### BACKGROUND OF THE INVENTION

Magcard payment is used more and more widely, and POS machines are used more and more. Swiping modes of conventional POS machines generally include a wireless swiping mode and a magnetic head reading swiping mode. Most POS machines usually adopt the conventional magnetic head reading swiping mode, that is, a magnetic head swiping device is mounted at a side of a POS machine. However, with the upgrading of cards, POS machines swiping wirelessly are also more and more. For ordinary customers, POS machines swiping with traditional magnetic heads are usually used in an initial stage of development, these POS machines are used widely, and their cost is low. After developing for a certain period, in order to improve user experience, the POS machines often need to be replaced or upgraded, such that POS machines having the function of wirelessly swiping are used; of course, in order to be adapted for common cards, the POS machines swiping wirelessly can also have the function of swiping by a magnetic head. However, since the manufacturers want to lower cost, for the POS machines that can be upgraded to have the function of wirelessly swiping, the casings thereof will use the same set of molds, and the difference is only whether a wireless swiping device is mounted in a casing. For this type of upgradeable POS machines, in the prior art, wireless swiping devices are usually not mounted in this type of casings, so that POS machines that can only swipe using magnetic heads are made; when a customer requires upgrading, the casings are opened, additional wireless swiping devices are mounted, wireless labels are marked onto the casings, and thus POS machines swiping wirelessly are made. However, when a POS machine is machined and manufactured, in order to ensure the security thereof and prevent user information from being stolen, the casing of the POS machine is usually provided therein with a security protection module configured to prevent from being detached and destroyed, and this type of security protection module is usually irreversible, that is, once it is damaged, it cannot be repaired. When this type of POS machine is upgraded, the casing needs to be disassembled, and the security protection module therein will be destroyed; the security protection module needs to be replaced again when upgrading, the upgrading is complicated, the efficiency is low, and the upgrading cost is often higher than the cost for directly replacing the POS machine with a new one.

### SUMMARY OF THE INVENTION

A purpose of the present invention is to provide a hidden wireless protection device, which is aimed at solve the problem that conventional POS machines that can be upgraded to wirelessly swipe are difficult to upgrade and have high cost.

The present invention is realized by the following solution: a hidden wireless swiping device, which comprises a circuit board configured to be electrically connected with a main board of a POS machine and a wireless module configured to wirelessly read information in a card; the hidden wireless swiping device further comprises a light transmission plate configured to be mounted on a casing of the POS machine to cover the wireless module and an indicator light mounted on the circuit board, at least one surface of the light transmission plate is a frosted surface, and the circuit board is provided thereon with a control circuit configured to control the wireless module and the indicator light to operate.

In the present invention, by the design of the hidden wireless swiping device, the light transmission plate of which one surface is arranged to be a frosted surface covers on the wireless module, the indicator light is arranged on the circuit board, and the control circuit is arranged on the circuit board to control the wireless module and the indicator light to be turned on/off and to operate. When the indicator light stops operating, since one surface of the light transmission plate is the frosted surface, it is difficult to see structures in the POS machine through the light transmission plate, and thus invisibility is realized. When the wireless module needs to be used, as long as the wireless module and the indicator light are controlled by the control circuit to operate, the wireless module can be enabled to operate. In this hidden wireless swiping device, when a user does not need a wireless swiping structure, he/she only needs to operate the control circuit via software, such that the hidden wireless swiping device is in a turned-off state, the POS machine can thus become a POS machine that swipes using a magnetic head only; while upgrading is required, he/she only needs to operate the control circuit via software, such that the hidden wireless swiping device is in an operating state, the POS machine can thus be upgraded into a POS machine swiping wirelessly; the upgrading is simple and convenient, and the cost is low; the casing of the POS machine needs not to be disassembled.

Another purpose of the present invention is to provide a POS machine, which comprises a casing, a main board mounted inside the casing, and a magnetic head swiping module mounted at a side of the casing; the aforesaid hidden wireless swiping device is also mounted inside the casing; the circuit board of the hidden wireless swiping device is connected with the main board, a portion of an upper surface of the casing corresponding to the wireless module defines an opening, the light transmission plate of the hidden wireless swiping device is mounted on the casing, and the light transmission plate covers on the opening.

For the POS machine of the present invention, when the hidden wireless swiping device does not operate, the POS machine is a POS machine that swipes using a magnetic head only; when the wireless module needs to be used, only the wireless module and the indicator light need to be controlled to operate, the upgrading is simple and convenient.

### BRIEF DESCRIPTION OF THE DRAWINGS

FIG. 1 is a perspective structural schematic view of a POS machine provided by an embodiment of the present invention;

FIG. 2 is a disassembled structural schematic view of the POS machine shown in FIG. 1;

FIG. 3 is a disassembled structural schematic view of a hidden wireless swiping device and a panel housing of the POS machine shown in FIG. 1;

FIG. 4 is a structural schematic view of the hidden wireless swiping device shown in FIG. 3, which is swiping;

FIG. 5 is a frontal structural schematic view of the POS machine shown in FIG. 1;

FIG. 6 is a perspective structural schematic view of mounting an electromagnetic pen at one side of the POS machine shown in FIG. 1;

FIG. 7 is an enlarged structural schematic view of the electromagnetic pen and a pen holder shown in FIG. 6;

FIG. 8 is a perspective structural schematic view of mounting an electromagnetic pen at another side of the POS machine shown in FIG. 1.

### DETAILED DESCRIPTION OF THE PREFERRED EMBODIMENT

In order to make the purposes, technical solutions, and advantages of the present invention be clearer, the present invention will be further described in detail hereafter with reference to the accompanying drawings and embodiments. It should be understood that the embodiments described herein are only intended to illustrate but not to limit the present invention.

In the description of the present invention, it needs to be noted that the positions or position relations indicated by position terms such as “middle”, “above”, “below” “horizontal”, “bottom”, “inside”, “outside”, and the like, are positions or position relations based on the arrangement of a device being used, and are only intended to describe the present invention conveniently and simplify the description, but do not express or imply that the indicated devices or components must have particular positions or be structured and operated in particular positions, and therefore should not be considered as limitations to the present invention.

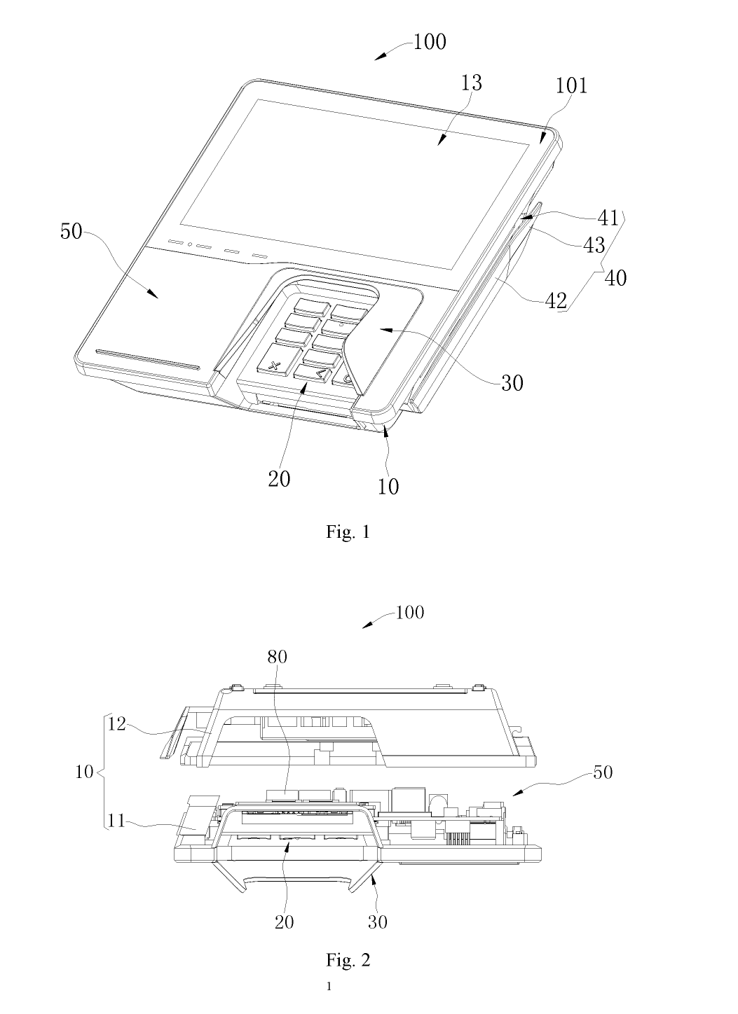

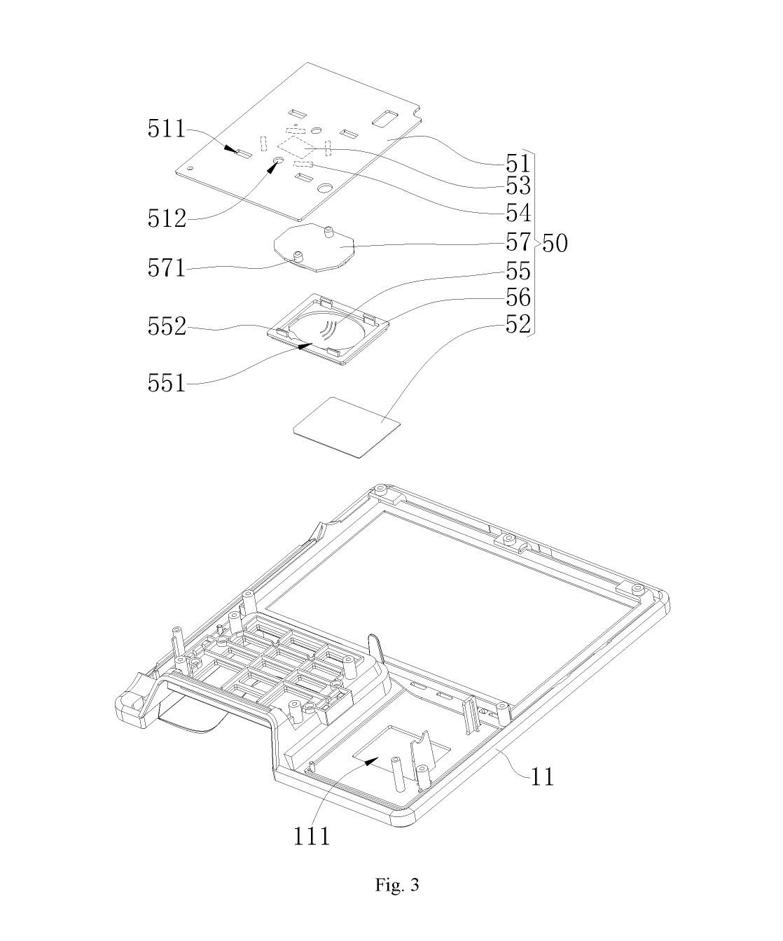

Please refer to FIG. 1, FIG. 2, and FIG. 3, one embodiment of the present invention provides a POS machine 100, which comprises a casing 10, a main board 80, a magnetic head swiping module 40, and a hidden wireless swiping device 50; the main board 80 is mounted inside the casing 10, and thus the main board 80 is protected by the casing 10; the magnetic head swiping module 40 is mounted at a side of the casing 10 so as to read user information in a card when swiping.

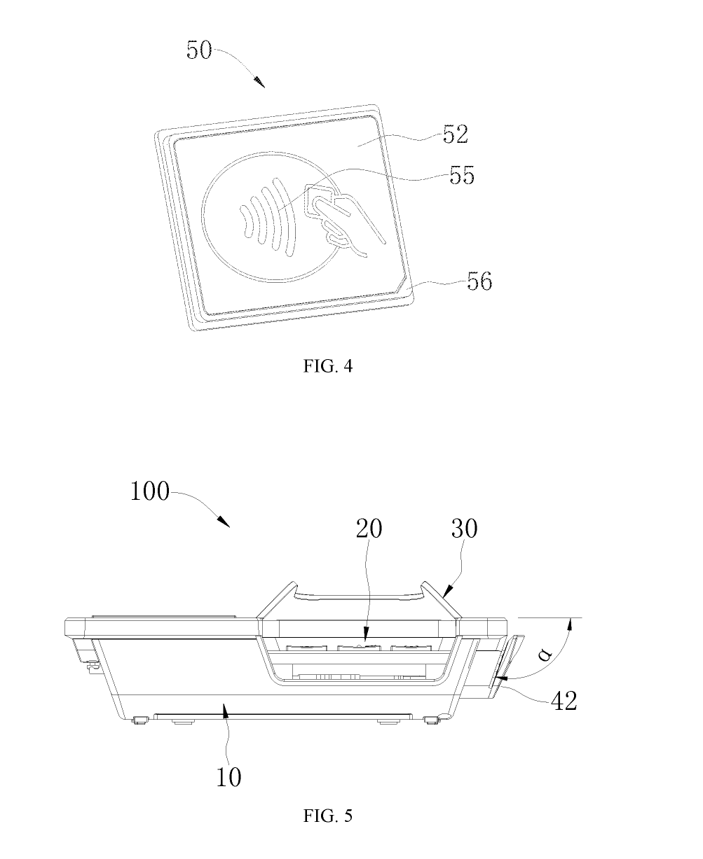

Please refer to FIG. 2, FIG. 3, and FIG. 4, the hidden wireless swiping device 50 includes a circuit board 51, a wireless module 53, a light transmission plate 52, and an indicator light 54; the circuit board 51 is configured to be electrically connected with the main board 80 of the POS machine 100, such that information read by the wireless module 53 can be input into the POS machine 100. The wireless module 53 is configured to wirelessly read information in cards. At least one surface of the light transmission plate 52 is a frosted surface, which is configured to cover the wireless module 53, and the light transmission plate 52 is mounted on the casing 10 of the POS machine 100; when there is no light in the casing 10, it is impossible to see structures inside the casing 10 through the light transmission plate 52, such that invisibility of the wireless module 53 is realized. A portion of the casing 10 corresponding to the wireless module 53 defines an opening 111, the light transmission plate 52 is mounted on the casing 10, and the light transmission plate 52 covers on the opening 111. The indicator light 54 is mounted on the circuit board 51, the circuit board 51 is provided thereon with a control circuit (not labeled in the drawings) configured to control the wireless module 53 and the indicator light 54 to operate. By means of the control circuit, the wireless module 53 and the indicator light 54 are controlled to be in an operating state or a turned-off state.

The light transmission plate 52 of which one surface is arranged to be a frosted surface covers on the wireless module 53, the indicator light 54 is arranged on the circuit board 51, and the control circuit is arranged on the circuit board 51 to control the wireless module 53 and the indicator light 54 to be turned on/off and to operate. When the indicator light 54 stops operating, since one surface of the light transmission plate 52 is the frosted surface, it is difficult to see structures in the POS machine 100 through the light transmission plate 52, and thus invisibility is realized. When the wireless module 53 needs to be used, as long as the wireless module 53 and the indicator light 54 are controlled by the control circuit to operate, the wireless module 53 can be enabled to operate.

In the POS machine 100, when the hidden wireless swiping device 50 does not operate, the POS machine 100 is a POS machine 100 that swipes using a magnetic head only; when the wireless module 53 needs to be used, only the wireless module 53 and the indicator light 54 need to be controlled to operate. Thus, the POS machine 100 can perform equipment upgrading according to requirements of users. When a user does not need a wireless swiping structure, he/she only needs to operate the control circuit via software, such that the hidden wireless swiping device 50 is in a turned-off state, the POS machine 100 can thus become a POS machine 100 that swipes using a magnetic head only; while upgrading is required, he/she only needs to operate the control circuit via software, such that the hidden wireless swiping device 50 is in an operating state, the POS machine 100 can thus be upgraded into a POS machine 100 swiping wirelessly; the upgrading is simple and convenient, and the cost is low; the casing 10 of the POS machine 100 needs not to be disassembled.

Furthermore, the hidden wireless swiping device 50 further comprises a wireless label 55 configured to display the operation of the wireless module 53, the wireless label 55 is arranged between the indicator light 54 and the light transmission plate 52. By the arrangement of the wireless label 55, when the wireless module 53 is in the operating state, the indicator light 54 emits light, the wireless label 55 can be seen through the light transmission plate 52, and thus users can know the wireless swiping area on the POS machine 100 conveniently, which is convenient for the users to use. When the wireless module 53 is in the turned-off state, the indicator light 54 goes out, and it is impossible to see the wireless label 55 through the light transmission plate 52. That is, when the hidden wireless swiping device 50 is turned off, users cannot know whether a wireless module 53 is mounted in the POS machine 100.

Furthermore, the hidden wireless swiping device 50 further comprises a covering plate 56 covering on the wireless module 53, the wireless label 55 is arranged on the covering plate 56, the covering plate 56 is mounted on the circuit board 51, at least one area of the covering plate 56 corresponding to the wireless label 55 is a light transmission area. By the arrangement of the covering plate 56, the wireless label 55 is arranged on the covering plate 56, such that it is possible that the wireless label 55 does not contact the light transmission plate 52 directly; thus, when the indicator light 54 goes out, light reflected by the wireless label 55 is better prevented from passing through the light transmission plate 52. By using an area of the covering plate 56 corresponding to the wireless label 55 as the light transmission area, when the indicator light 54 emits light, it is possible that the light transmission plate 52 can better display the wireless label 55. The arrangement of the covering plate 56 can further provide the function of protecting the wireless module 53.

In this embodiment, the covering plate 56 is a light shading plate (i.e., an opaque plate), and the wireless label 55 is an aperture defined in the covering plate 56; when the indicator light 54 emits light, light enters the light transmission plate 52 through the aperture, and thus projects the wireless label 55 on the light transmission plate 52. In other embodiments, the covering plate 56 can also be a transparent plate, and the wireless label 55 can be a paster attached on the covering plate 56; similarly, when being irradiated by light, the wireless label 55 can be projected on the light transmission plate 52.

The covering plate 56 can be engaged on the circuit board 51 to facilitate assembly. In particular, the covering plate 56 is provided thereon with at least one hook 552, and the circuit board 51 defines at least one through hole 511 configured to allow the hook 552 to insert, correspondingly. By inserting the hook 552 into the corresponding through hole 511, the covering plate 56 is thereby engaged on the circuit board 51.

Furthermore, the indicator light 54 is located at a side edge of the wireless module 53, the hidden wireless swiping device 50 further comprises a light guiding plate 57 configured to guide light emitted by the indicator light 54 to the bottom of the covering plate 56, and the light guiding plate 57 is arranged between the wireless module 53 and the covering plate 56. By the arrangement of the light guiding plate 57, when the indicator light 54 emits light, the brightness at the wireless label 55 can be improved, such that the wireless label 55 is better displayed. The wireless module 53 can be an NFC module, and can also be a radiofrequency module.

In order to improve the displaying brightness and reduce heat generated by a single indicator light 54, a plurality of indicator lights 54 can be mounted on the circuit board 51, and the plurality of indicator lights 54 are arranged around the wireless module 53.

Furthermore, the covering plate 56 defines a groove 551 configured to cooperatively receive the light guiding plate 57. By arranging the groove 551 on the covering plate 56, the light guiding plate 57 can be positioned and mounted conveniently. Meanwhile, the arrangement of the groove 551 can also reduce a thickness of the hidden wireless swiping device 50.

Furthermore, in order to mount the light guiding plate 57 conveniently, the light guiding plate 57 is provided thereon with at least one protruding positioning post 571, and a portion of the circuit board 51 corresponding to the positioning post 571 defines at least one positioning hole 512 configured to cooperatively allow the positioning post 571 to insert. By the arrangement of the positioning post 571 and the positioning hole 512, the light guiding plate 57 can be positioned conveniently, meanwhile, the light guiding plate 571 is prevented from moving.

When assembling the hidden wireless swiping device 50, the positioning post 571 on the light guiding plate 57 can be firstly inserted into the positioning hole 512 of the circuit board 51 correspondingly, the hook 552 on the covering plate 56 is then inserted into the through hole 511 of the circuit board 51, and thus the covering plate 56 is mounted on the circuit board 51. When mounting the hidden wireless swiping device 50, the circuit board 51 can be fixed inside the casing 10 of the POS machine 100, and the light transmission plate 52 is then fixed on the casing 10.

Please refer to FIG. 1 and FIG. 5, furthermore, the magnetic head swiping module 40 includes a card swiping module 41 configured to read information in cards and a clamping board 42 configured to cooperate with the card swiping module 41 to clamp a card and thereby guide the card, a lower side of the clamping board 42 is fixedly connected with the casing 10. By the arrangement of the clamping board 342, the card is guided to slide on the card swiping module 41, such that the swiping operation is performed better. Meanwhile, the clamping board 42 can also provide the function of protecting the card swiping module 41.

Furthermore, the clamping board 42 is arranged obliquely with respect to an upper surface 101 of the casing 10, and an inclined angle α of the clamping board 42 with respect to the upper surface 101 of the casing 10 ranges from 100 to 120 degrees. When swiping a card, the POS machine 100 is usually placed on a horizontal table, and meanwhile a clamping board 42 of a conventional POS machine 100 is usually positioned vertically; when the card is inserted between the card swiping module 41 and the clamping board 42, the card needs to be positioned vertically; however, when a person positions the card normally, the card may appear a certain angle with respect to a vertical direction, which may result in that the angle of the card needs to be passively adjusted when the card is inserted between the card swiping module 41 and the clamping board 42, and thus the card may be worn. On the contrary, if the range of the inclined angle α of the clamping board 42 with respect to the upper surface 101 of the casing 10 is set to be 100-120 degrees, the amount by which the angle of the card needs to be passively adjusted can be reduced, so that the abrasion of the card can be reduced and a user can feel more comfortable when swiping the card.

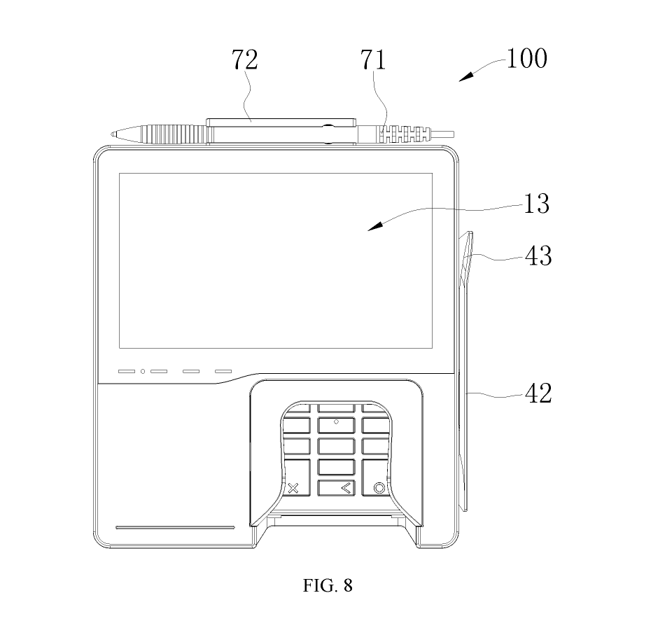

Please refer to FIG. 1, FIG. 5 and FIG. 8, furthermore, one end of the clamping board 42 is provided with a guiding board 43 opening towards a direction that is away from the casing 10. Since the clamping board 42 and the card swiping module 41 need to cooperatively clamp the card so as to guide and adjust the angle of the card, a distance between the clamping board 42 and the card swiping module 41 is small, and a good alignment is required when swiping the card. By the arrangement of the guiding board 43, the card can be guided between the clamping board 42 and the card swiping module 41 more conveniently, thereby facilitating swiping cards and improving the comfort level of swiping cards.

Furthermore, please further refer to FIG. 2, the casing 10 includes a bottom housing 12 and a panel casing 11 covering above the bottom housing 12, and a receiving cavity (not labeled in the drawings) is formed between the bottom housing 12 and the panel housing 11; the main board 80 is mounted inside the receiving cavity, and the hidden wireless swiping device 50 is fixed in the receiving cavity. Please also refer to FIG. 3, a portion of the panel housing 11 corresponding to the wireless module defines an opening 111, the light transmission plate 52 is mounted on the panel housing 11, and the light transmission panel 52 covers the opening 111. The casing 10 is formed by combining the bottom housing 12 with the panel housing 11, and the machining and the manufacturing are simple and convenient.

Furthermore, in this embodiment, the casing 10 is further provided thereon with a keyboard 20 configured to input user information, and the keyboard 20 is electrically connected with the main board 80. By the arrangement of the keyboard 20, users can input information such as passwords conveniently, and thus the application range of the POS machine 100 is improved. Of course, in other embodiments, the POS machine 100 can also be connected with an external input device, such as a keyboard 20. In further other embodiments, the POS machine 100 can be directly connected with a computer main board 80, and information is input through a computer keyboard 20.

Furthermore, a peep-proof cover 30 configured to cover at least three side edges of the keyboard 20 is mounted on the casing 10. By the arrangement of the peep-proof cover 30, when a user inputs information such as a password, the side edges of the keyboard 20 can be covered, peep is prevented, and thus user information is better prevented from being stolen.

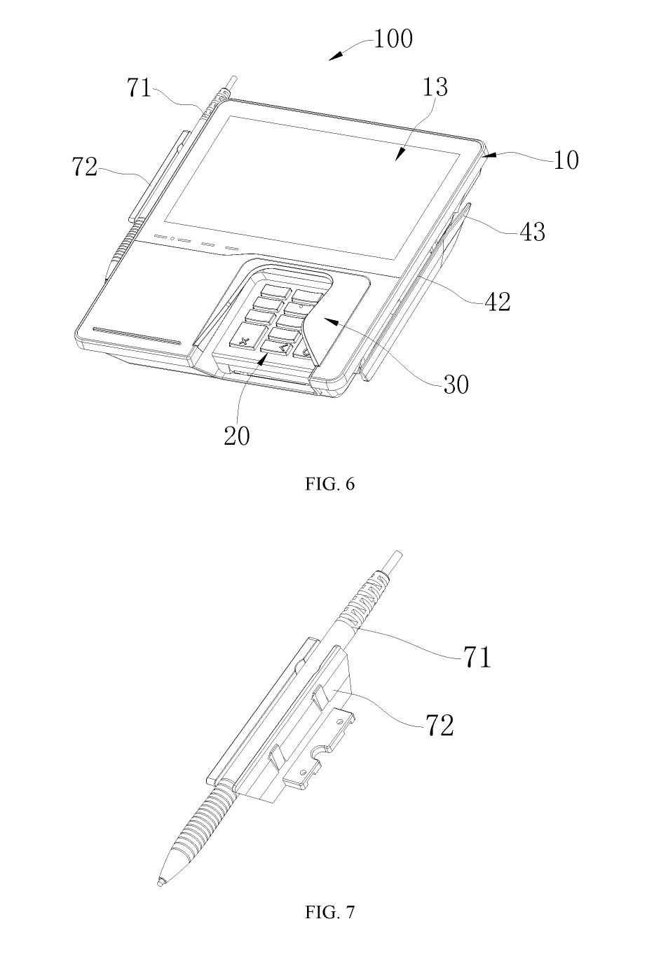

Please refer to FIG. 6, FIG. 7, and FIG. 8, furthermore, in order to help users view in use, the casing 10 is further provided thereon with a display screen 13, and the display screen 13 is electrically connected with the main board 80. By the arrangement of the display screen 13, information, such as consumption, can be displayed, which is more intuitive and convenient. Additionally, the display screen 13 can be a touch screen, so that users can operate and use more conveniently.

In this embodiment, the display screen 13 is an electromagnetic display screen. The POS machine 100 further includes an electromagnetic pen 71 configured to input information on the electromagnetic display screen. By the use of the electromagnetic display screen and the electromagnetic pen 71, users can sign conveniently, so that electronic operation is improved and use of paper is reduced, which is more environmentally friendly and more convenient.

Furthermore, a penholder 72 configured to clamp the electromagnetic pen 71 is mounted at a side of the casing 10. By the arrangement of the penholder 72, the electromagnetic pen 71 can be positioned conveniently. In this embodiment, the penholder 72 is fixed on the casing 10 by screws, and the casing 10 defines screw holes correspondingly. Please refer to FIG. 6, the penholder 72 can be mounted on a left side of the POS machine 100. The clamping board 42 and the penholder 72 are respectively located at two opposite sides of the casing 10. In other embodiments, please refer to FIG. 8, the penholder 72 can be mounted at a rear side of the POS machine 100, such that the mounting location of the penholder 72 can be determined according to various locations for positioning the POS machine 100, and users can use conveniently.

The above are only preferred embodiments of the present invention and are not intended to limit the present invention. Any modification, equivalent replacement, and improvement made within the spirit and principle of the present invention should be included in the protection scope of the present invention.

1. A hidden wireless swiping device, comprising a circuit board configured to be electrically connected with a main board of a POS machine and a wireless module configured to wirelessly read information in a card; wherein, the hidden wireless swiping device further comprises a light transmission plate configured to be mounted on a casing of the POS machine to cover the wireless module and an indicator light mounted on the circuit board, at least one surface of the light transmission plate is a frosted surface, and the circuit board is provided thereon with a control circuit configured to control the wireless module and the indicator light to operate.

2. The hidden wireless swiping device according to claim 1, wherein, the hidden wireless swiping device further comprises a wireless label configured to display the operation of the wireless module, and the wireless label is arranged between the indicator light and the light transmission plate.

3. The hidden wireless swiping device according to claim 1, wherein, the hidden wireless swiping device further comprises a covering plate covering on the wireless module, the wireless label is arranged on the covering plate, the covering plate is mounted on the circuit board, and at least one area of the covering plate corresponding to the wireless label is a light transmission area.

4. The hidden wireless swiping device according to claim 3, wherein, the indicator light is located at a side edge of the wireless module, the hidden wireless swiping device further comprises a light guiding plate configured to guide light emitted by the indicator light to the bottom of the covering plate, and the light guiding plate is arranged between the wireless module and the covering plate.

5. The hidden wireless swiping device according to claim 4, wherein, the covering plate defines a groove configured to cooperatively receive the light guiding plate.

6. The hidden wireless swiping device according to claim 4, wherein, the light guiding plate is provided thereon with at least one protruding positioning post, and a portion of the circuit board corresponding to the positioning post defines at least one positioning hole configured to cooperatively allow the positioning post to insert.

7. The hidden wireless swiping device according to claim 3, wherein, the wireless label is an aperture defined in the covering plate.

8. The hidden wireless swiping device according to claim 3, wherein, the covering plate is provided thereon with at least one hook, and the circuit board defines at least one through hole configured to allow the hook to insert, correspondingly.

9. A POS machine, comprising a casing, a main board mounted inside the casing, and a magnetic head swiping module mounted at a side of the casing; wherein, the hidden wireless swiping device according to claim 1 is mounted inside the casing; the circuit board of the hidden wireless swiping device is connected with the main board, a portion of an upper surface of the casing corresponding to the wireless module defines an opening, the light transmission plate of the hidden wireless swiping device is mounted on the casing, and the light transmission plate covers on the opening.

10. The POS machine according to claim 9, wherein, the magnetic head swiping module includes a card swiping module configured to read information in cards and a clamping board configured to cooperate with the card swiping module to clamp a card and thereby guide the card, a lower side of the clamping board is fixedly connected with the casing.

11. The POS machine according to claim 10, wherein, the clamping board is arranged obliquely with respect to an upper surface of the casing, and an inclined angle of the clamping board with respect to the upper surface of the casing ranges from 100 to 120 degrees.

12. The POS machine according to claim 10, wherein, one end of the clamping board is provided with a guiding board opening towards a direction that is away from the casing.

13. The POS machine according to claim 9, wherein, the casing includes a bottom housing and a panel casing covering above the bottom housing, and a receiving cavity is formed between the bottom housing and the panel housing; the main board is mounted inside the receiving cavity, the hidden wireless swiping device is fixed in the receiving cavity, and the light transmission plate is mounted on the panel housing.

14. The POS machine according to any claim 9, wherein, the casing is further provided with a keyboard configured to input user information, and the keyboard is electrically connected with the main board.

15. The POS machine according to claim 14, wherein, a peep-proof cover configured to cover at least three side edges of the keyboard is mounted on the casing.

16. The POS machine according to claim 9, wherein, the casing is further provided with a display screen, and the display screen is electrically connected with the main board.

17. The POS machine according to claim 16, wherein, the POS machine further comprises an electromagnetic pen configured to input information on the electromagnetic display screen, and the display screen is an electromagnetic display screen.

18. The POS machine according to claim 17, wherein, a penholder configured to clamp the electromagnetic pen is mounted at a side of the casing.
